(19) United States
(12) Patent Application Publication
(10) Pub. No.: US 2001/0003198 A1
(43) Pub. Date: Jun. 7, 2001

(54) Method for timing setting of a system memory

(76) Inventor: Chung-Che Wu, Taipei (TW)

Correspondence Address: RABIN & CHAMPAGNE, PC, 1101 14TH STREET, NW, SUITE 500, WASHINGTON, DC, 20005, US

(21) Appl. No.: 09/725,235

(22) Filed: Nov. 29, 2000

(30) Foreign Application Priority Data
Nov. 30, 1999 (TW) 88120841

(51) Int. Cl. G06F 12/00

(52) U.S. Cl. 711/104; 711/167; 711/170

(57) ABSTRACT

A method for setting timing of a system memory in a computer system. The system memory includes a number of memory modules. Each memory module optionally includes individual serial presence detect (SPD) data which record the characteristics of the memory module. Individual SPD data includes a module operating frequency and a set of timing values for the corresponding memory module. The method includes steps as follows: reading individual SPD data of each memory module successively for finding a system memory operating frequency that is operable for all of the memory modules and determining each set of timing values of each memory module; and initializing the system memory according to the system memory operating frequency and each set of timing values.

This application is incorporated herein by reference Taiwan application Serial No. 88120841, filed on Nov. 30, 1999.

### BACKGROUND OF THE INVENTION

1. Field of the Invention

The invention generally relates to a method for timing setting of a system memory in a computer system, and more particularly to a method for timing setting of a system memory for optimizing the system memory performance.

2. Description of the Related Art

System memory, or main memory, of computer systems is very important for the performance and stability of computer systems. System memory generally comprises various volatile memory modules, such as, fast page mode DRAM (FPM DRAM) module, extended data out DRAM (EDO DRAM) module, burst EDO DRAM (BEDO DRAM) module, or synchronous DRAM (SDRAM) module, For ever-increasing the system performance, processors with higher clock frequency are desired. However, the memory performance still cannot catch up with the performance of the processor because the data access rate of memory device is lower than the clock frequency of the processor. The data access rate is restricted to the technology that the memory device applies. With technology improved, the data rate of the system memory is getting faster and faster. So, there are various DRAMs with different operating frequencies and timing values.

In a computer system, the system memory operates at a predetermined frequency. Users conventionally set this frequency by utilizing jumper caps to connect jumper pins on the main board.

Referring to FIG. 1, the architecture of a conventional computer system related to system memory access is shown in block diagram form. A central processing unit (CPU) 102 is connected to the system memory 106 through the north bridge chip 104, which contains a memory controller 108. The system memory 106 usually includes a number of memory modules, such as DRAM or SDRAM modules, which are possibly with different operating characteristics. Each memory module comprises a number of memory chips and may further comprise a nonvolatile memory, for example an electrically erasable programmable read-only memory (EEPROM), which contains configuration data for that memory module, such as timing settings. The CPU 102 controls the system memory 106 through the system memory controller 108. While initialization, the system memory is set to operate at a frequency according to the jumper setting on the main board and the timing values are read from the EEPROM of the memory modules through the system management bus (SMbus) to be stored in the system memory controller 108.

Referring to FIG. 2, the timing diagram for DRAM access cycle is shown. For a DRAM access cycle, there are 3 main operations: ROW active, read/write command and pre-charge. At time t₁, DRAM begins to be Row active. At time t₂, DRAM begins to perform read/write command; in other words, the system memory controller sends a read/write command to DRAM. At time t₃, DRAM sends the required data. At time t₄, DRAM begins to perform pre-charge. At time t₅, DRAM performs the operation of ROW active for the next access to DRAM.

In view of the timing sequence mentioned above, several timing values are defined as follows. The time interval, Trcd, between the beginning to perform ROW active and the beginning to perform a read/write command is called row address strobe (RAS) to column address strobe (CAS) delay, i.e. t_{RCD}=t₂−t₁. The number of clock during the time interval from sending a read command to DRAM to outputting the required data from DRAM, i.e. t₂ to t₃, is defined as CAS latency and denoted as CL. The time interval, measured from the beginning of ROW active operation to the beginning of pre-charge operation, i.e. t₄−t₁, is defined as RAS pulse width time, and denoted as t_{RAS}. The time interval measured from the beginning of pre-charge operation to the beginning of the next ROW active operation, i.e. t₅−t₄, is defined as ROW pre-charge time and denoted as t_{RP}.

On the other hand, the EEPROM of the memory module contains serial presence detect (SPD) data for DRAM chips thereon. SPD is an industrial specification to store the detailed characteristics of DRAM. The SPD data may include size, architecture and timing values in different frequencies of DRAM. Every byte of SPD data contains a value indicating specific meaning for the DRAM characteristics. Most of the SPD data can be mapped to the registers of a system memory controller for timing setting. The bytes of SPD data that are defined for timing setting are, for example, as follows:

Byte A (e.g. byte 9): the clock cycle time when CL is the highest value, usually CL=3;

Byte B (e.g. byte 18): the CL values supported by DRAM;

Byte C (e.g. byte 23): the clock cycle time when the CL is the sub-maximum value, usually CL=2;

Byte D (e.g. byte 27): the minimum t_{RP};

Byte E (e.g. byte 29): the minimum t_{RCD};

Byte F (e.g. byte 30): the minimum t_{RAS}; and

Byte G (e.g. byte 126): the operating frequency (e.g. 66 MHz or 100 MHz) that the memory module supports.

Referring now to FIG. 3, the flowchart of the conventional method for timing setting of a system memory is shown. Timing setting of a system memory is performed during booting a computer system. At step 302, the SPD data of system memory are read. Next, at step 304, it is determined whether a memory module exists and is operable at the predetermined frequency. If the previous test fails, the computer system halts as shown in step 306. Otherwise, the system memory is initialized as shown in step 308; in other words, the SPD data are written into the system memory controller for initialization of the system memory.

Conventionally, the operating frequency of the system memory must be supported by the CPU, since the stability of the memory modules operating at a predetermined frequency is concerned. If a memory module operates at a frequency higher than the frequencies supported by the memory module, the computer system becomes unstable and even halts. If the CPU does not support the highest operating frequency supported by the memory module, the memory module can only operate at lower frequency that the memory module supports. Possibly, the user possibly uses a number of memory modules manufactured by different vendors or supporting different specifications, e.g. the industrial standard PC66 PC100, and PC133 for the computer system. For the sake of stability, the lowest frequency that all the memory modules can operate at is selected to be the predetermined operating frequency and the slowest timing values are selected. Therefore, the conventional approach results in the memory performance degradation.

### SUMMARY OF THE INVENTION

It is therefore an object of the invention to provide a method for timing setting of a system memory in a computer system. The method requires no jumper setting for a predetermined operating frequency and makes the memory modules with different characteristics in a computer system operating with their optimal timing values, resulting in optimal memory performance.

In accordance with the object of the invention, a method for timing setting of a system memory is disclosed. The system memory includes a number of memory modules. Each memory module optionally includes individual serial presence detect (SPD) data which record the characteristics of the memory module. Individual SPD data includes a module operating frequency and a set of timing values for the corresponding memory module. The method includes steps as follows: first, reading individual SPD data from each memory module successively for finding a system memory operating frequency that is operable for all of the memory modules and determining each set of timing values of each memory module; and initializing the system memory according to the system memory operating frequency and each set of timing values.

### BRIEF DESCRIPTION OF THE DRAWINGS

Other objects, features, and advantages of the invention will become apparent from the following detailed description of the preferred but non-limiting embodiments. The description is made with reference to the accompanying drawings in which:

FIG. 1 (Prior Art) shows a block diagram of the architecture related to access to system memory in a conventional computer system;

FIG. 2 (Prior Art) illustrates the relationship between timing sequence and timing parameters;

FIG. 3 (Prior Art) shows a flowchart of the conventional method for timing setting of the system memory of a computer system;

FIG. 4 shows a flowchart of a method for timing setting of a system memory in accordance with a preferred embodiment of the invention; and

FIGS. 5A to 5D shows flowcharts of the detailed steps of step 402 in FIG. 4.

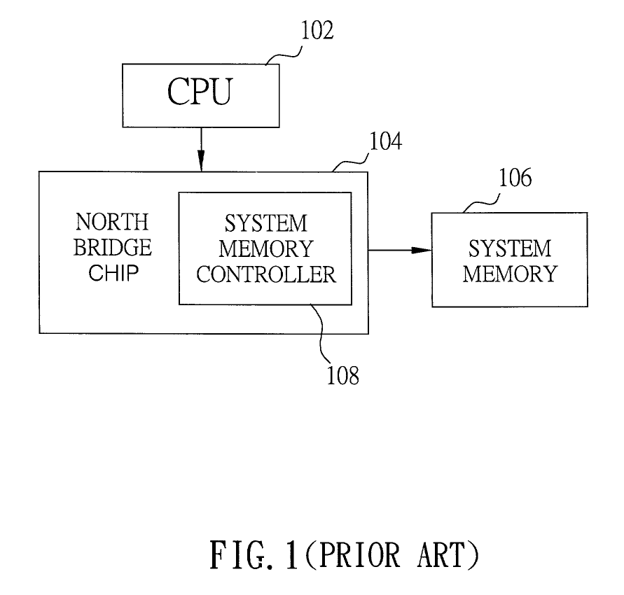

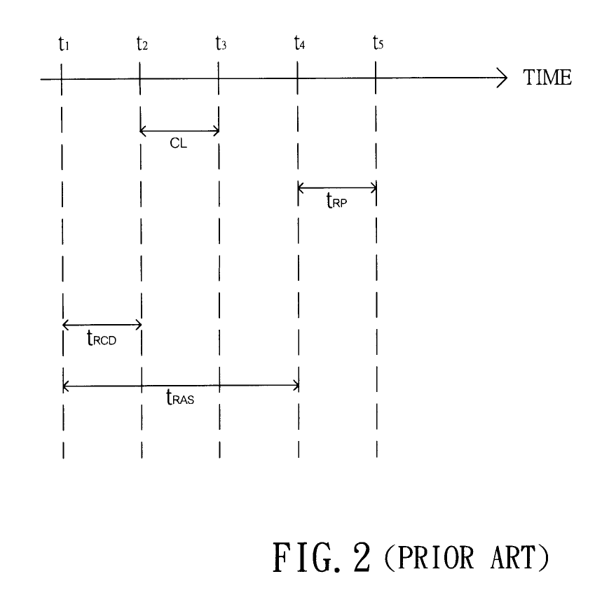

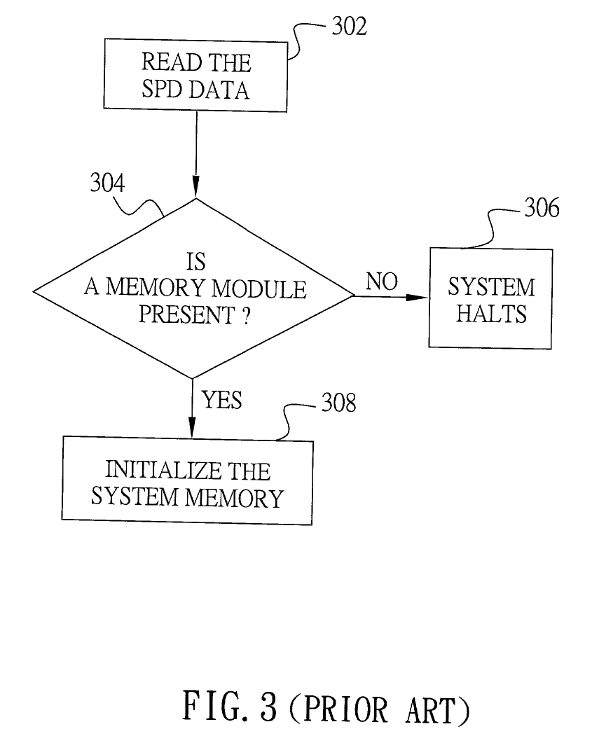

### DESCRIPTION OF THE PREFERRED EMBODIMENT

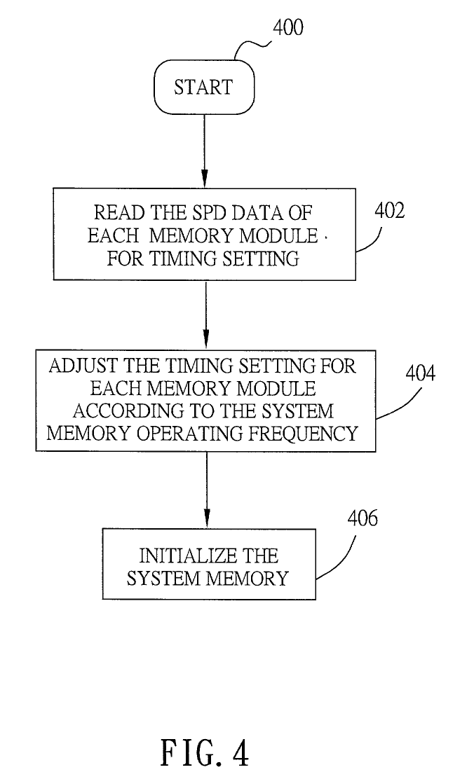

Referring to FIG. 4, a flowchart of a method for timing setting of a system memory in accordance with a preferred embodiment of the invention is shown. First, the method begins at step 400 and proceeds to step 402. At step 402, the serial presence detect (SPD) data of each memory module, are read successively and the operating frequency and timing values are determined from the SPD data. At step 404, adjusting the timing values for each memory module according to the system memory operating frequency found at the step 402. So, the optimal timing values under the operating frequency are determined for each memory module. The method proceeds to step 406. At step 406, all the memory modules are initialized by a system memory controller with the optimal operating frequency and timing values that are determined in previous steps, therefor the optimal timing setting values are written into the system memory controller's registers.

As mentioned above, the optimal operating frequency (module operating frequency) and timing values of the memory modules are determined from the SPD data of all memory modules. Most of the SPD data can be mapped to the registers of the system memory controller directly or through simple operations, except for the operating frequency and CAS latency, or CL.

The operating frequency of the memory module is mainly determined according to the bytes A and G of SPD data mentioned above. The byte G indicates the memory modules supporting a first frequency, such as 66 MHz, or a second frequency, such as 100 MHz. On the other hand, the industrial standard specification of SPD data does not specify the timing values at frequency other than 66 MHz and 100 MHz, such as 133 MHz for SDRAM modules. Therefore, byte A is adopted to indicate the memory module supporting a third frequency, such as 133 MHz. Byte A of SPD data is ordinarily used to indicate the clock cycle time when CL value is the highest of all possible values of CL, usually when CL=3. When the memory module supports an operating frequency of 133 MHz, the clock cycle time is not greater than 7.5 ns. In this case, byte A can be set to 75h for indicating that the memory module supports operating at frequency 133 MHz.

CL is mainly determined according to bytes B and C of SPD data. Byte B indicates which CL values, such as 2 and 3, are supported when the memory module operating at the lowest frequency, such as 66 MHz. Byte C indicates the clock cycle time when the CL value is the sub-maximum value, such as 2. If the clock cycle time is not greater than a first clock cycle time, such as 10 nanosecond (ns), which is represented by setting the byte C to A0h, then CL value can be set to the sub-maximum value when the memory module is operating at a second frequency, such as 100 MHz. If the clock cycle time is not greater than a second clock cycle time, such as 7.5 ns, which is represented by setting the byte C to 75h, it indicates that the memory module supports operating at a third frequency, such as 133 MHz, and the CL value can be set to the sub-maximum value.

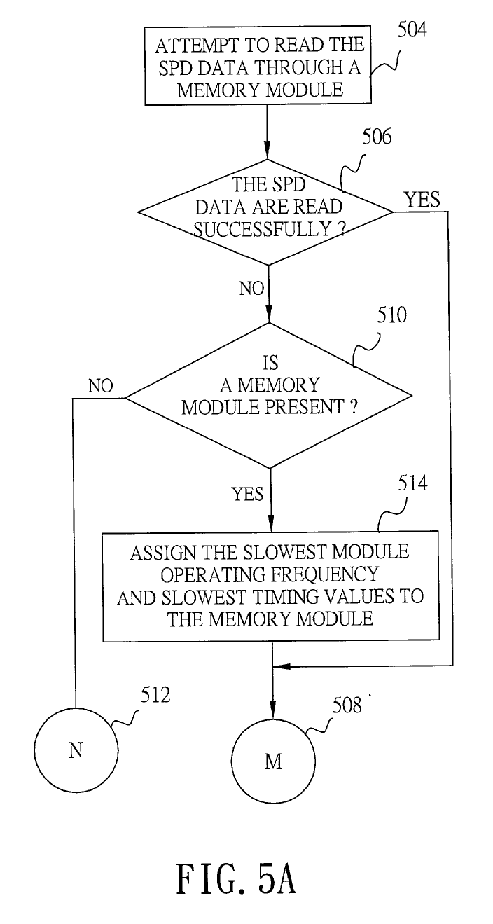

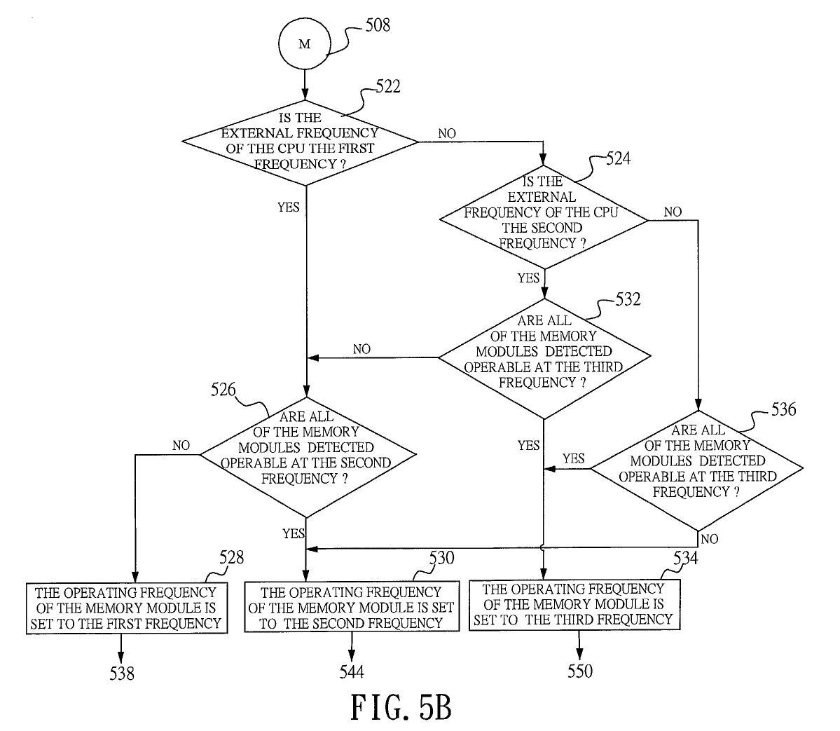

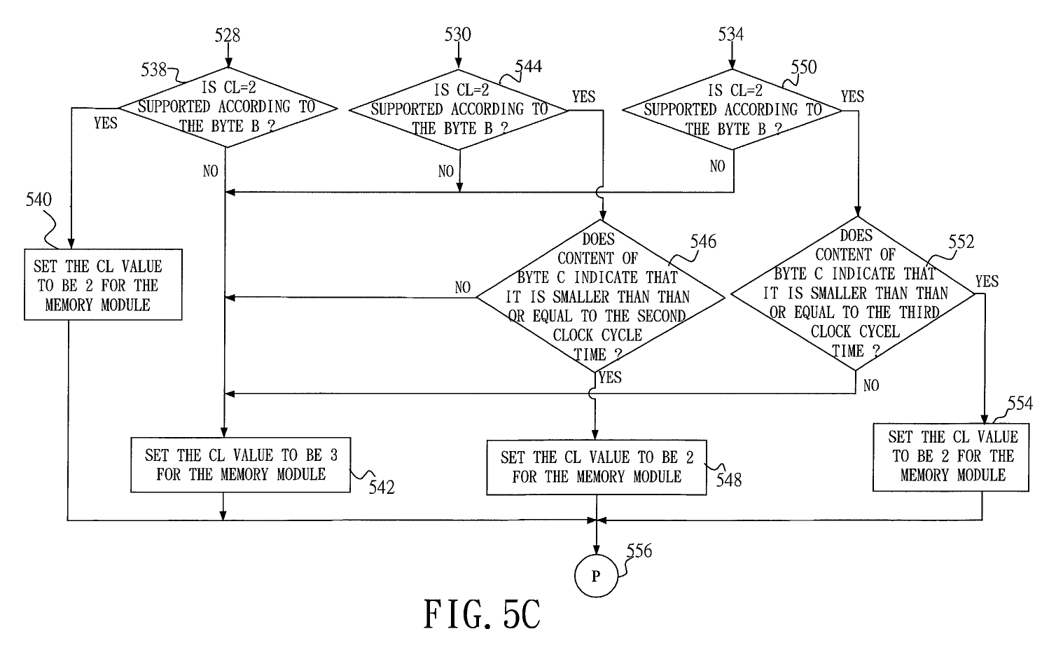

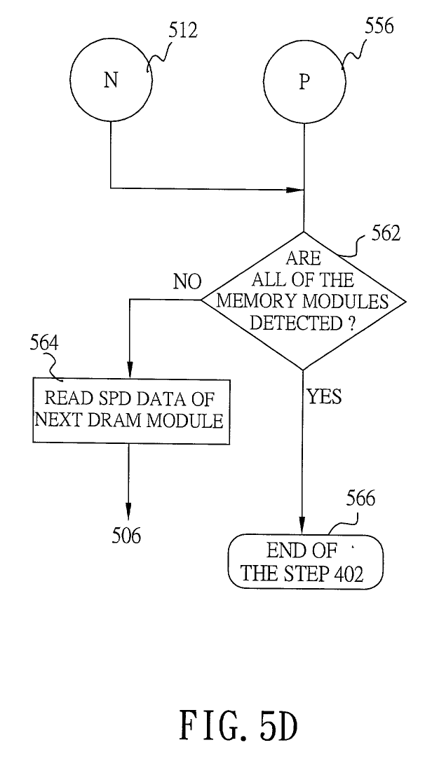

Referring now to FIGS. 5A-5D, flowcharts of the detailed steps of step 402 in FIG. 4 are shown. In the following, the determination of the operating frequency and timing values is described. For the sake of simplification, only the determination of the operating frequency and CL of one memory module is described, and some conditions are made as follows. The external frequency of the CPU (host bus frequency), or front side bus (FSB) frequency, is limited to the first or the second frequency, such as 66 Hz or 100 MHz. The difference between external frequency of the CPU and the operating frequency of system memory (system memory operating frequency) is not greater than 33 MHz. The highest frequency that a memory module can operate is the third frequency, such as 133 MHz. It should be noted, for the implementation of the invention, that these restrictions are not necessary. The remaining timing values of SPD data can be set by applying the principle of the method successively that will not be described here for simplification.

The step 402 in FIG. 4 includes a number of steps shown in FIGS. 5A to 5D.

Referring now to FIG. 5A, at step 504, the SPD data, such as bytes A and G, are read through one of the memory modules. Next, at decision step 506, if the SPD data are read successfully, the method traverses the YES branch to node M, i.e. step 508. If not, at decision step 506, the method traverses the NO branch to step 510. At step 510, it determines whether a memory module exists. Because there are two situations that the SPD data cannot be read: the memory module does not support SPD data or actually no memory module exists. If no memory module exists, the method traverses the NO branch to node N, i.e. step 512: If DRAM module does not support SPD data, the method traverses the YES branch to step 514. For the sake of stability of the memory operation, at step 514, set the memory module with the lowest operating frequency and the slowest timing values. Then, after step 514, the method proceeds to node M, i.e. step 508.

Referring now to FIG. 5B, at node M (or step 508), the method proceeds to step 522. If, at decision step 522, the external frequency of the CPU is not the first frequency, the method proceeds to step 524. At step 524, it is determined whether the external frequency of the CPU is the second frequency. If, at decision step 522, the first frequency is the external frequency of the CPU, the method proceeds to step 526. After the external frequency of the CPU is determined, the operating frequency of the memory module is to be determined. Thus, at step 526, it is determined whether all memory modules that have been detected are operable at the second frequency. If so, the method proceeds to step 530; otherwise, the method proceeds to step 528. At step 528, the first frequency is taken as the operating frequency of the memory module. At step 530, the second frequency is selected as the operating frequency of the memory module.

If, at step 524, the external frequency of the CPU is the second frequency, the method proceeds to step 532. At step 532, it is determined whether all memory modules that have been detected can operate at the third frequency. If so, the method proceeds to step 534. If not, the method proceeds to step 526. At step 534, the third frequency is selected as the operating frequency of the memory module.

If, at step 524, the external frequency of the CPU is not the second frequency, the method proceeds to step 536. At step 536, it is determined whether all memory modules that have been detected can operate at the third frequency. If so, the method proceeds to step 534. At step 534, the third frequency is taken as the operating frequency of the memory module. If, at step 536, the third frequency is not operable, the method proceeds to step 530. At step 530, the second frequency is taken as the operating frequency of the memory module.

At this stage, the setting of the operating frequency of the memory module is done. The following task is to determine the optimal timing values for the memory module. Referring to FIG. 5C, a flowchart for setting the optimal CL value of the memory module is shown. Please note that, at step 528 in FIG. 5B, the first frequency is taken as the operating frequency of the memory module and the method proceeds to step 538 in FIG. 5C. At step 538, the byte B of the memory module's SPD data is used to determine whether it supports CL value of 2. If so, the method proceeds to step 540. If not, the method proceeds to step 542. At step 540, the CL value of the memory module is set to 2. At step 542, the CL value of the memory module is set to 3.

Please note that, at step 530 in FIG. 5B, the second frequency is taken as the operating frequency of the memory module and the method proceeds to step 544 in FIG. 5C. At step 544, it is determined whether it supports the CL value of 2 from the byte B of SPD data of the memory module. If so, the method proceeds to step 546. If not, the method proceeds to step 542. At step 542, the CL value of the memory module is set to 3. At step 546, it is determined whether the Byte C of the SPD data is smaller than or equal to the second clock cycle time. If so, it indicates that the memory module supports CL value of 2 when the second frequency is taken as the operating frequency of the memory module and the method proceeds to step 548. If not, the method proceeds to step 542. At step 542, the CL value of the memory module is set to 3. At step 548, the CL value of the memory module is set to 2.

Similarly, please not that, at step 534 in FIG. 5B, the operating frequency of the memory module is set to the third frequency and the method proceeds to step 550 in FIG. 5C. At step 550, it is determined that whether the memory module supports CL value of 2 from the byte B of the SPD data of the memory module. If so, the method proceeds to step 552. If not, the method proceeds to step 542. At step 542, the CL value of the memory module is set to 3. At step 552, it is determined whether the value of Byte C is smaller than or equal to the third clock cycle time. If so, it indicates that the value of CL supports 2 when the third frequency is taken as the operating frequency of the memory module and the method proceeds to step 554. If not, the method proceeds to step 542. At step 542, the CL value of the memory module is set to 3. At step 554, the CL value of the memory module is set to 2.

At this stage, the setting for CL value of the memory module is done. After steps 540, 542, 548 and 554, the method proceeds to node P, i.e. step 556.

Referring now to FIG. 5D, after node N (i.e. step 512) and node P (i.e. step 556), the method proceeds to step 562. At step 562, it is determined whether all of the memory modules are detected and their SPD data are read. If so, the method proceeds to step 566. If not, the method proceeds to step 564. At step 564, the detection is switched to the next memory module and the method proceeds to step 506 in FIG. 5A again. At step 566, the step 402 is finished and the method proceeds to step 404 in FIG. 4. At step 404, the timing values are adjusted to be optimal for all of the memory modules according to the operating frequency found at the step 402, in the way disclosed in FIG. 5C. At step 406, all of the memory modules are initialized by the system memory controller. During the initialization, the registers for timing setting of the system memory controller are set according to the optimal operating frequency found at step 402 and the timing values adjusted at step 404. By the method above, the setting for the operating frequency and timing values is completed and the system memory, therefore, makes its optimal performance.

In the method describe above, the execution of step 402 is to find an optimal operating frequency from the SPD data of all memory modules. After the optimal operating frequency is determined for the system memory, the execution of step 404 is to determine the optimal timing values. An example of setting the operating frequency and CL value is explained as follows.

Assume that the system memory of a computer system contains two DRAM modules, respectively denoted as M1 and M2. The CL value of module M1 is 2 when M1 operating at 66 MHz. When M1 is operating at 100 MHz, the CL value of module M1 is 3. Also assume that module M2 only supports operating at 66 MHz. The CL value of module M2 is 2. When the method described above is performed, at step 402, the SPD data of module M1 is read firstly. At step 402, it is found that module M1 can operate at 100 MHz and the CL value can be set to 3. Next, the SPD data of module M2 is read and it is found that module M2 only operates at 66 MHz and its CL value is 2. Thus, after the execution of step 402, the operating frequency of the system memory is set to 66 MHz, the CL value of module M1 is 3 and the CL value of module M2 is 2. However, the CL value of module M1 can be further adjusted set to a smaller value, i.e. 2, when module M1 is operating at 66 MHz.

For the sake of optimization, step 404 is performed. Since the operating frequency 66 MHz for the system memory is determined after the execution of step 402, in the adjustment of step 404, the CL value of module M1 is adjusted to 2. Thus, after the execution of step 404, the optimal CL value for each memory module is determined for the best performance of the system memory.

However, the above step 404 is optional. Without the step 404, the operating frequency of the system memory and the timing values for each memory module still can be determined.

Besides, another example of the invention is described as follows: first, reading all of the SPD data available from all memory modules and finding a system operating frequency that is operable for all memory modules; next, adjusting each set of timing values for each memory module according to the system operating frequency found in the previous step; and initializing the system memory according to the system operating frequency and each set of timing values determined in the previous one step.

While the invention has been described by way of example and in terms of the preferred embodiment, it is to be understood that the invention is not limited to the disclosed embodiment. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for timing setting of a system memory, the system memory able to support N memory module(s) but actually comprising M present memory module(s), M, N being positive integers and M≦N, each present memory module optionally comprising individual module specification data which record the characteristics of said memory module, individual module specification data comprising a module operating frequency and a set of timing values, the method comprising the steps of:
(a) reading individual module specification data from each memory module successively to find a system memory operating frequency that is operable for all of the memory modules and determine each set of timing values of each memory module; and
(b) initializing the system memory according to the system memory operating frequency and each set of timing values.

2. The method according to claim 1, wherein the module specification data is a serial presence detect (SPD) data.

3. The method according to claim 2, wherein each memory module is respectively defined as the ith memory module, 1≦i≦N, i is an integer, the individual SPD data for the ith memory module is the ith SPD data, the ith SPD data records the ith module operating frequency that the ith memory module supports and the ith set of timing values, wherein the step (a) comprises the steps of:
(a1) setting i=1;
(a2) attempting to read the ith SPD data of the ith memory module;
(a3) setting the system operating frequency according to the ith SPD data if the ith SPD data is read successfully;
(a4) if i=N and the ith memory module is not present, then ending the step (a);
(a5) if i<N and the ith memory module is not present, increasing i by 1 and repeating from step (a2);
(a6) setting the ith memory module with a predetermined frequency and a predetermined set of timing values if the ith SPD data fails to be read successfully;
(a7) determining the ith set of timing values of the ith memory module according to the system memory operating frequency set in the step (a3); and
(a8) if i<N, increasing i by 1 and repeating from step (a2).

4. The method according to claim 2, wherein the ith set of the timing values of the ith memory module comprises a column address strobe latency (CAS latency, i.e. CL) value, a minimum row pre-charge time, a minimum row-address-strobe (RAS) to column-address-strobe (CAS) delay time, and a minimum row-address-strobe pulse width time.

5. The method according to claim 1, between the steps (a) and (b) further comprising:
(b0) adjusting each set of timing values for each memory module according to the system memory operating frequency found in the step (a).

6. The method according to claim 5, wherein the step (b0) comprise:
adjusting each set of timing values to be optimal for each memory module corresponding to the system memory operating frequency found in the step (a).

7. The method according to claim 1, wherein the memory modules are fast page mode DRAM (FPM DRAM) modules, extended data out DRAM (EDO DRAM) modules, burst EDO DRAM (BEDO DRAM) modules, or synchronous DRAM (SDRAM) modules.

8. The method according to claim 1, wherein the SPD data are individually stored in a nonvolatile memory of each memory module.

9. The method according to claim 8, wherein the nonvolatile memory is an electrical erasable programming read only memory (EEPROM).

10. The method according to claim 1, wherein the system memory operating frequency is 66 MHz, 100 MHz, or 133 MHz.

11. A method for timing setting of a system memory, the system memory comprising at least one memory module, each memory module optionally comprising module specification data which record the characteristics of said corresponding memory modules, individual SPD data comprising a module operating frequency and a set of timing values, the method comprising the steps of:
(a) reading all of the module specification data available from all of the memory modules and finding a system memory operating frequency that is operable for all memory modules;
(b) adjusting each set of timing values for each memory module according to the system memory operating frequency found in the step (a); and
(c) initializing the system memory according to the system memory operating frequency and each set of timing values determined in the step (b).

12. The method according to claim 11, wherein the module specification data is a serial presence detect (SPD) data.

13. The method according to claim 11, wherein the system memory operating frequency is determined to be slowest if any memory module does not support module specification data.

14. The method according to claim 13, wherein the step (b) comprises:
adjusting each set of timing values to be optimal for each memory module corresponding to the system memory operating frequency found in the step (a).
